(19) United States
(12) Patent Application Publication
(10) Pub. No.: US 2018/0087764 A1
(43) Pub. Date: Mar. 29, 2018

(54) SOLAR POWERED ILLUMINATING CONTAINER

(71) Applicant: Thurman Davenport, Park City, KS (US)

(72) Inventor: Thurman Davenport, Park City, KS (US)

(21) Appl. No.: 15/275,847

(22) Filed: Sep. 26, 2016

(51) Int. Cl. F21V 33/00; F21V 7/00; F21V 14/04; F21V 23/04; F21S 9/03; B65D 81/38; B65D 43/16; B65D 51/24; B65D 25/28; F25D 3/06; F25D 23/12; F25D 23/02; F25D 27/00

(52) U.S. Cl. CPC F21V 33/008; F21Y 2115/10; F21V 14/04; F21V 23/04; F21S 9/03; F21V 23/0464; B65D 81/3813; B65D 43/163; B65D 51/245; B65D 25/2808; F25D 3/06; F25D 23/12; F25D 23/028; F25D 27/00; F21V 7/00

(57) ABSTRACT

An illuminating container comprises an insulated housing used for storing at a cool temperature. The housing comprises a solar portion that harvests solar energy to generate electricity, and thereby constantly recharge a power source. The power source powers an illumination portion to emit a light towards an interior cavity of the housing. An adjustable reflector directionally guides the light towards the cavity, or in other directions. A positional switch triggers the illumination portion to power on when the lid is opened, which is useful at night time or dark places. A photoresistor exhibits photoconductivity to enable selective lighting by the illumination portion when it is substantially dark. The position of the lid and the intensity of the incident light determine whether the illumination portion is powered on or off. A power switch overrides both the position switch and the photoresistor in powering on and off the illumination portion.

### CROSS-REFERENCE TO RELATED APPLICATIONS

The present Utility patent application claims priority benefit of the U.S. provisional application for patent Ser. No. 62/222,966 entitled “SOLAR BRITE LITE ICE CHEST” filed 24 Sep. 2015 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS A TEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to an illuminating container. More particularly, certain embodiments of the invention relates to an insulated housing that harvests solar energy to power a directionally adjustable illumination portion towards an interior cavity of the housing, and also provides a positional switch that powers on the illumination portion when the lid is in an open position, and a photoresistor that exhibits photoconductivity to enable selective lighting by the illumination portion when it is substantially dark; whereby the illumination portion is not powered on unnecessarily when there is sufficient lighting to see inside the cavity of the housing

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a cooler, or ice chest is an insulated box used to keep food or drink cool. Ice cubes are most commonly placed in it to help the things inside stay cool. Ice packs are sometimes used, as they either contain the melting water inside, or have a gel sealed inside that stays cold longer than plain ice.

Typically, light sources in remote or rural areas require their own power supply. A light source, such as a standard light bulb, powered by one or two C or D size alkaline batteries may requires a fair amount of electrical power to operate over an extended period of time.

Generally, a position switch or sensor is any device that permits position measurement. The position switch can either be an absolute position sensor or a relative one (displacement sensor). Position sensors can be linear, angular, or multi-axis.

Often, a photoresistor is a light-controlled variable resistor. The resistance of a photoresistor decreases with increasing incident light intensity; in other words, it exhibits photoconductivity. In many instances, a photoresistor can be placed in streetlights to control when the light is on. Ambient light falling on the photoresistor causes the streetlight to turn off. Thus energy is saved by ensuring the light is only on during hours of darkness.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a front perspective view of an exemplary illuminating container, in accordance with an embodiment of the present disclosure;

FIG. 2 illustrates a rear perspective view of an illuminating container, in accordance with an embodiment of the present disclosure; and

FIG. 3 illustrates a front perspective view of an exemplary housing of the illuminating container, showing the lid in an open position and an illumination portion directing light towards a cavity in the container, in accordance with an embodiment of the present disclosure.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [“substantially”] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

### Terminology

The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

The present invention will now be described in detail with reference to embodiments thereof as illustrated in the accompanying drawings.

There are various types of insulated containers that may be provided by preferred embodiments of the present invention.

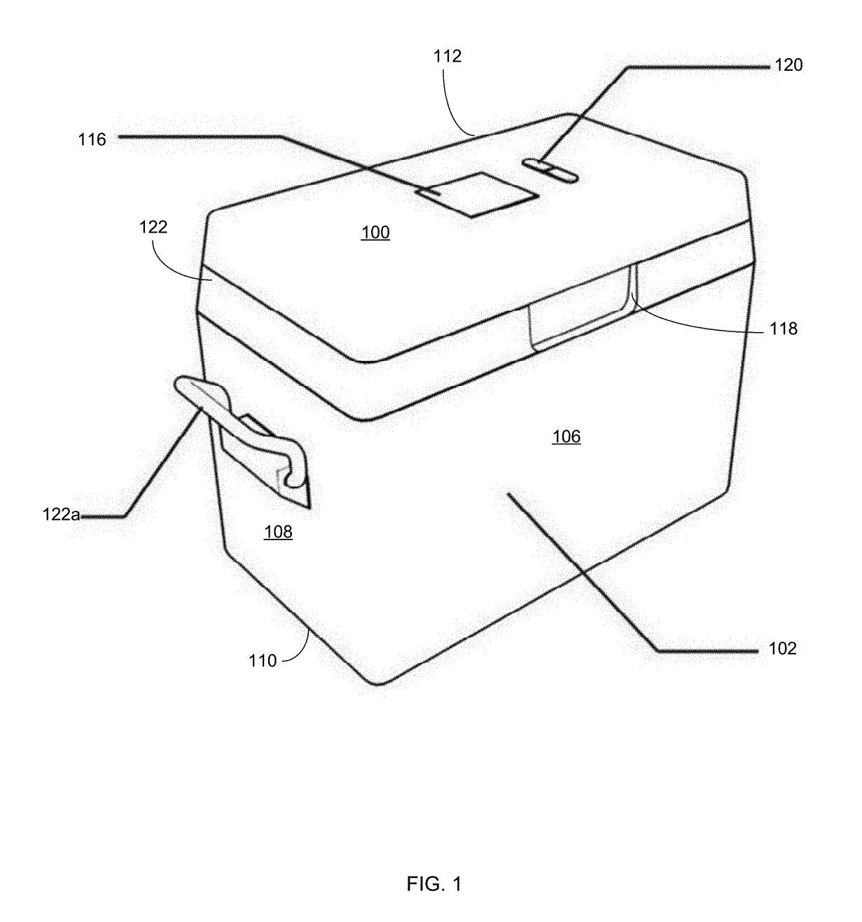

FIG. 1 illustrates a front perspective view of an exemplary illuminating container 100. In one aspect, the illuminating container comprises an insulated housing used for storing food and beverages at a cool temperature. The housing comprises a solar portion that harvests solar energy to generate electricity, and thereby constantly recharge a power source. The power source powers an illumination portion to emit a light towards an interior cavity of the housing. An adjustable reflector directionally guides the light towards the cavity, or in other directions.

In some embodiments, a positional switch triggers the illumination portion to power on when the lid is opened allowing the user to see clearly the contents of the housing, especially at night time or in dark places. The illuminating container also provides a photoresistor that exhibits photoconductivity to enable selective lighting by the illumination portion when it is substantially dark. In this manner, the illumination portion is not powered on unnecessarily when there is sufficient lighting to see inside the cavity of the housing. However, a power switch overrides both the positional switch and the photoresistor in powering on and off the illumination portion.

Looking again at FIG. 1, the illuminating container may include a housing 102 having an outer surface formed by a top 104, a bottom 110, a first side 106, a second side, a first end 108, and a second end. The top having a first opening therein to form a cavity defined by an interior surface. In some embodiments, the housing may have a generally rectangular shape. Though in other embodiments, the housing may be shaped in other dimensions, including, without limitation, cubicle, circular, and pyramidal.

In some embodiments, the container further comprises a thermally insulating interior body. The thermally insulating interior body may be received within the housing cavity and comprises at least one wall. Those skilled in the art will recognize that a cooler, or ice chest, is an insulated box used to keep food or drink cool. Ice cubes are most commonly placed in it to help the things inside stay cool. When camping, picnicking, boating, or going to the beach, food may be kept cool and last longer when secured in the cooler.

Thus, the thermally insulating interior body allows the container to operate as a cooler. In some embodiments, the wall may be fabricated from an insulative material, including, without limitation, foam, polystyrene, and a nonconductive, porous material. The wall may be between ⅛″ to 2″ thick. Though in other embodiments, the container may be a general container, and not have insulative properties. In some embodiments, the first and second ends of the housing may include at least one handle 122a, 122b. The handle may have a generally U-shape and facilitate manipulation and carrying of the container.

In some embodiments, the container may further include a lid 112 having a lid outer surface 114 and a lid inner surface. The lid regulates access to the cavity of the housing. The lid may be pivotally attached to the top of the housing, so as to be pivotable between an open position and a closed position that encloses the body cavity of the housing. In one embodiment, the lid may also have insulative properties. In some embodiments, a depression 118 may be formed at one edge of the lid. The depression provides a space for gripping the edge of the lid to move the lid from the closed position to the open position.

In some embodiments, the container may further include a power source being operable to at least partially provide electrical power. The power source may include, without limitation, a battery, a rechargeable battery, a direct current power source, and an external power source. In some embodiments, a solar portion 116 may be received within at least a portion of said outer surface of said lid. The solar panel is configured to convert solar energy into electrical energy.

Thus, the solar portion may be disposed to optimize exposure to the sun. The solar portion may be electrically coupled to continuously recharge the power source. In one embodiment, a substantial amount of electricity stored in the power source is received from the solar portion. In some embodiments, the solar portion may include, without limitation, a solar panel and a photovoltaic cell.

In some embodiments, the container may further include an illumination portion that is received within at least a portion of the inner surface of the lid. The illumination portion may be electrically coupled to the power source, such that the electricity from the power source is used to at least partially power the illumination portion. The illumination portion being configured to emit a light. The illumination portion may include a light emitting diode, a halogen lamp, and a torch. The illumination may include any color or pattern known in the art.

In some embodiments, the container may further include a reflector portion coupled to the illumination portion. The reflector portion may at least partially surround the illumination portion, so as to reflect the light in a direction. The reflector portion further may also adjustably orient in a plurality of directions, whereby the direction of the reflected light from the illumination portion is oriented in the direction of the reflector. The reflector may rotate about a plane 400 of the inner surface of the lid so as to direct the light up to 360° along the plane 400 of the lid, and also towards the cavity of the housing. In this manner, both the contents of the housing, and the peripheral area of the housing may be selectively illuminated.

In one embodiment, the reflector is positioned to direct the light into the cavity of the housing to allow a clear vision of the contents of the housing, especially at night time or in dark places. However, the reflector may be rotated to direct the light form the illumination portion along the sides of the lid to perform other tasks in better lighting.

In some embodiments, the container may further include a position switch that permits position measurement of the lid. The position switch operatively joins with the lid and the illumination portion through electrical coupling. The position switch may serve to measure the orientation of a plane of the lid relative to the top of the housing. Thus, when the lid moves from a generally horizontal orientation to a generally perpendicular orientation relative to the top of the housing, the position switch triggers the illumination portion to power on. In this manner, the illumination portion emits a light when the lid moves from the closed position to the open position.

Conversely, when the lid moves from a generally perpendicular orientation to a generally horizontal orientation relative to the top of the housing, the position switch triggers the illumination portion to power off. In this manner, the illumination portion stops emitting a light when the lid moves from the open position to the closed position.

In one embodiment, the position switch may include a spring-biased button received at the edges of the top of the housing. In this embodiment, the position switch may operates based on the weight of the lid. When the lid is in the closed position and fully resting on the spring-biased button, the illumination portion is powered off. However, when the lid is lifted off the edge of the top of the housing, and thereby the spring-biased button, the spring-biased button extends from the edge of the housing, causing the illumination portion to power on.

In another embodiment, the position switch may include an angular switch that measures absolute angles or relative angles of the lid in relation to the housing. In yet other embodiments, the position switch may include, without limitation, a tilt switch, a tilt actuator, a multi-axis displacement transducer, a Hall switch, a grating sensor, and a seismic displacement pickup.

In an alternative embodiment, the container may further include a photoresistor that also works to power on and off the illumination portion, independently of the position switch. The photoresistor may be received within at least a portion of the outer surface of said lid or the outer surface of the housing. The photoresistor is configured to have varying electrical conductivity based on the intensity of incident light. The incident light being defined as a ray of light that strikes the outer surface of the lid and the housing.

In some embodiments, the photoresistor may be electrically coupled to power on the illumination portion when the incident light falls below a predetermined intensity, and also when the lid is moved to the open position. In one embodiment, the predetermined intensity of said incident light is about 1,000 lux illuminance.

For example, when it is dark and when the lid is in the open position. Conversely, the photoresistor may be electrically coupled to power off the illumination portion when the incident light exceeds a predetermined intensity, and also when the lid is moved to the closed position. For example, when it is light and when the lid is in the closed position.

The photoresistor may be operationally independent of the position switch. In this manner, either the position switch or the photoresistor may cause the illumination portion to emit a light. This can be useful when the lid is only partially opened, yet it is still dark. Here, the position switch may not power on the light, however, the photoresistor may do so. Also, if one component mechanically fails, the other serves as a backup.

In some embodiments, the container may further include a power switch 120 that powers on and off the illumination portion. The power switch overrides the position switch and the photoresistor. In on embodiment, the power switch may be received within at least a portion of the outer surface of said lid or the outer surface of the housing. In this manner, if the power switch is turned off, neither the position switch nor the photoresistor may power on or off the illumination portion. And if the power switch is powered on, either the position switch or the photoresistor may power on or off the illumination portion.

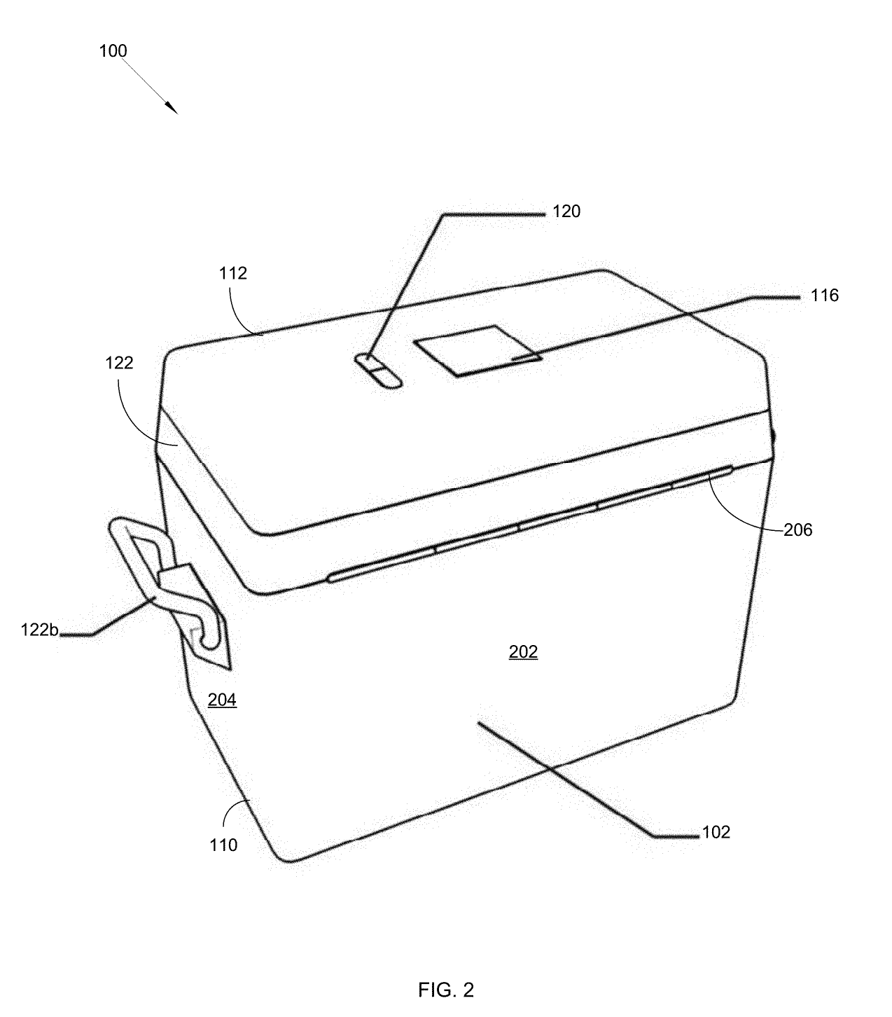

FIG. 2 illustrates a rear perspective view of an illuminating container. In one aspect, the container may include a housing that may form a storage for food and drink. In some embodiments, the housing may be used to contain food and beverages for trips and general outings over a duration. The thermally insulating interior body may help to maintain ice and other cold components in the cavity of the container at a predetermined temperature, which may be less than 60° Fahrenheit. Those skilled in the art will recognize that maintaining food and beverage at this temperature may enhance food taste and safety.

The sidewalls of the container a top 104, a bottom 110, a first side 106, a second side 202, a first end 108, and a second end 204 may be sufficiently rigid to withstand physical forces and impact. The lid may also be rigid and hingedly join the top of the container at a hinge portion 206. Suitable materials for the housing and the lid may include, without limitation,

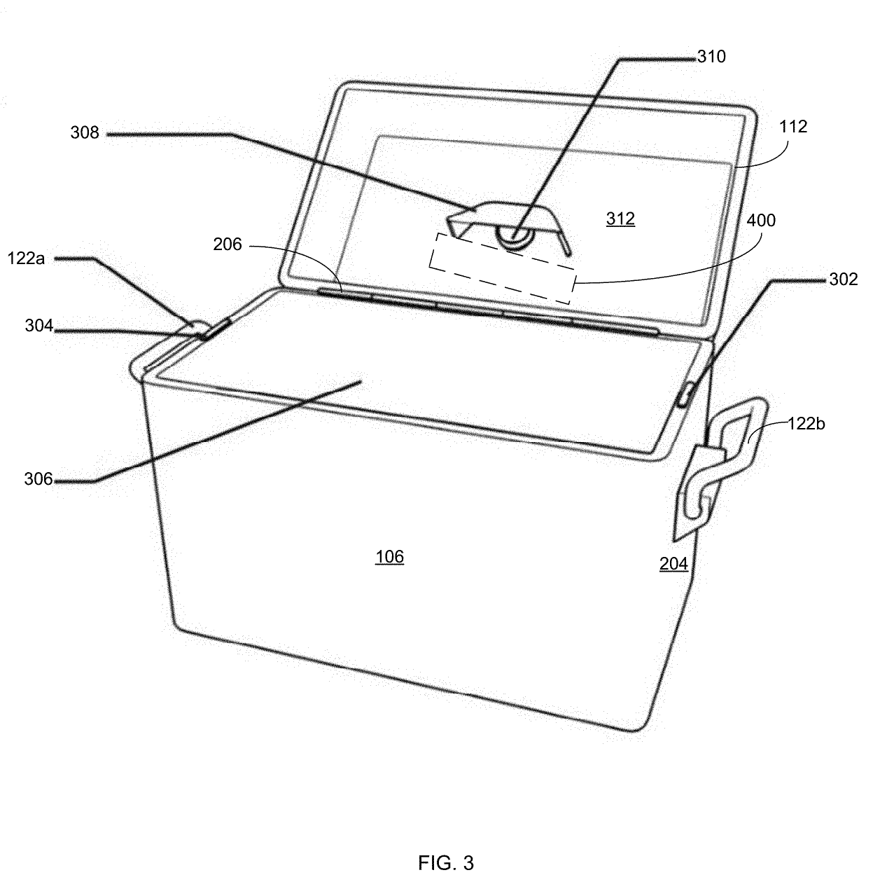

FIG. 3 illustrates a front perspective view of a housing, showing the lid in an open position and an illumination portion 310 directing light towards a cavity in the interior surface 306 of the housing. In one aspect, the cavity is where the food and beverages are placed for storage. Thus, in the dark, the directional light of the illumination portion may be useful for viewing the contents of the housing. A reflector 308 at least partially encapsulates the illumination portion and rotates about the plane of an inner surface 312 of the lid so as to direct the light up to 360° along the plane 400 of the lid, and also towards the cavity of the housing. In this manner, both the contents of the housing, and the peripheral area of the housing may be selectively illuminated. However, in other embodiments, the reflector may be rotated to direct the light towards any other direction relative to the lid, so as to guide the light from the illumination portion in multiple directions.

As discussed above, a position switch 302, or a photoresistor 304, or both may be used by the illuminating container to actuate the illumination portion. The powering on and off of the illumination portion may be at least partially based on the position of the lid relative to the top of the housing, or the intensity of incident light, or both. Further, a power switch, which may be accessible form the outer surface of the lid, provides overriding powering off and on of the illumination portion; thereby overriding the position switch and the photoresistor.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112 (6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing an illuminating container that is insulated and emits a light towards the cavity when the lid is opened according to the present invention will be apparent to those skilled in the art. Various aspects of the invention have been described above by way of illustration, and the specific embodiments disclosed are not intended to limit the invention to the particular forms disclosed. The particular implementation of the illuminating container that is insulated and emits a light towards the cavity when the lid is opened may vary depending upon the particular context or application. By way of example, and not limitation, the illuminating container that is insulated and emits a light towards the cavity when the lid is opened described in the foregoing were principally directed to an ice chest that utilizes a position switch and a photoresistor to operate a light that is dependent on the position of the lid and the intensity of incident light implementations; however, similar techniques may instead be applied to any type of container or box that would benefit from selective lighting, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

What is claimed is:

1. A system comprising:
a housing having an outer surface formed by a top, a bottom, a first side, a second side, a first end, and a second end, said top having a first opening to form a cavity defined by an interior surface;
a thermally insulating interior body, said thermally insulating interior body being received within said housing cavity and comprising at least one wall;
a lid, said lid having a lid outer surface and a lid inner surface, said lid being pivotally attached to said housing to be pivotable between an open position and a closed position that encloses said body cavity of said housing;
a power source being operable to at least partially provide electrical power;
a solar portion received within at least a portion of said outer surface of said lid, or at least a portion of said outer surface of said housing, said solar portion being configured to convert solar energy to electricity, said solar portion being electrically coupled to continuously recharge said power source;
an illumination portion received within at least a portion of said inner surface of said lid, said illumination portion being electrically coupled to said power source, said illumination portion being configured to emit a light;
a reflector portion joined with said illumination portion, said reflector portion further being configured to adjustably orient in a plurality of directions, said reflector portion being configured to at least partially direct said light from said illumination portion towards said cavity of said housing and along a plane of said inner surface of said lid, whereby direction of said light emitting from said illumination portion is adjustable;
a position switch being operatively joined with said illumination portion and said lid, said position switch being electrically coupled to power on said illumination portion when said lid moves from said closed position to said open position, and power off said illumination portion when said lid moves from said open position to said closed position; and
a power switch being operatively joined with said illumination portion, said power switch further being configured to power on and power off said illumination portion, whereby said power switch overrides said position switch.

2. The system of claim 1, further comprising a photoresistor received within at least a portion of said outer surface of said lid.

3. The system of claim 2, wherein said photo resistor is configured to have varying electrical conductivity based on the intensity of incident light, said photoresistor being electrically coupled to power on said illumination portion when said incident light falls below a predetermined intensity and when said lid is moved to said open position, and to power off said illumination portion when said incident light exceeds said predetermined intensity and when said lid is moved to said closed position.

4. The system of claim 3, in which said predetermined intensity of said incident light comprises about 1,000 lux illuminance.

5. The system of claim 4, wherein said power switch overrides said photoresistor.

6. The system of claim 5, in which said housing comprises a generally rectangular shape.

7. The system of claim 6, in which said housing comprises at least one handle.

8. The system of claim 7, in which said top of said housing comprises a depression.

9. The system of claim 8, in which said housing includes at least one of the following: polyurethane, polyethylene, polyvinyl chloride, and a rigid polymer.

10. The system of claim 9, in which said thermally insulating interior body includes at least one of the following: foam, polystyrene, and a nonconductive, porous material

11. The system of claim 10, wherein said lid joins said top of said housing at a hinge portion.

12. The system of claim 11, in which said power source includes at least one of the following: a battery, a rechargeable battery, and a direct current power source.

13. The system of claim 12, in which said solar portion includes at least one of the following: a solar panel, a solar cell, and a photovoltaic cell.

14. The system of claim 13, in which said illumination portion includes at least one of the following: a light emitting diode, a halogen lamp, and a torch.

15. The system of claim 14, wherein said reflector portion comprises a hood having a notch.

16. The system of claim 15, wherein said notch of said hood enables passage of said light from said illumination portion.

17. The system of claim 16, in which said reflector portion is configured to rotate about a plane of said inner surface of said lid.

18. The system of claim 17, in which said position switch comprises a spring-biased button.

19. A system comprising:
means for storing;
means for regulating access to said storage means;
means for illuminating said storage means at least partially based on positioning of said regulating means;
means for illuminating said storage means at least partially based on lighting; and
means for accessing said storage means.

20. A system consisting of:
a housing having an outer surface formed by a top, a bottom, a first side, a second side, a first end, and a second end, said top having a first opening to form a cavity defined by an interior surface;
at least one handle being disposed to extend from said first end and said second end of said housing;
a depression extending across said top of said housing;
a thermally insulating interior body, said thermally insulating interior body being received within said housing cavity and comprising at least one wall;
a lid, said lid having a lid outer surface and a lid inner surface, said lid being pivotally attached to said housing to be pivotable between an open position and a closed position that encloses said body cavity of said housing;
a hinge being configured to hingedly join said top of said housing with said lid;
a power source being operable to at least partially provide electrical power, said power source comprising a battery;
a solar panel received within at least a portion of said outer surface of said lid, or at least a portion of said outer surface of said housing, said solar panel being configured to convert solar energy to electricity, said solar panel being electrically coupled to continuously recharge said power source;
an illumination portion received within at least a portion of said inner surface of said lid, said illumination portion being electrically coupled to said power source, said illumination portion being configured to emit a light;
a reflector portion joined with said illumination portion, said reflector portion further being configured to adjustably orient in a plurality of directions, said reflector portion being configured to at least partially direct said light from said illumination portion towards said cavity of said housing and along a plane of said inner surface of said lid, whereby direction of said light emitting from said illumination portion is adjustable;
a position switch being operatively joined with said illumination portion and said lid, said position switch being electrically coupled to power on said illumination portion when said lid moves from said closed position to said open position, and power off said illumination portion when said lid moves from said open position to said closed position;
a power switch being operatively joined with said illumination portion, said power switch further being configured to power on and power off said illumination portion, whereby said power switch overrides said position switch; and
a photoresistor received within at least a portion of said outer surface of said lid, said photoresistor being configured to have varying electrical conductivity based on the intensity of incident light, said photoresistor being electrically coupled to power on said illumination portion when said incident light falls below a predetermined intensity and when said lid is moved to said open position, and to power off said illumination portion when said incident light exceeds said predetermined intensity and when said lid is moved to said closed position.
